(19) United States
(12) Patent Application Publication
(10) Pub. No.: US 2018/0376205 A1
(43) Pub. Date: Dec. 27, 2018

(54) METHOD AND APPARATUS FOR REMOTE PARENTAL CONTROL OF CONTENT VIEWING IN AUGMENTED REALITY SETTINGS

(71) Applicant: THOMSON Licensing, Issy- les Moulineaux (FR)

(72) Inventors: Urvashi OSWAL, Madison, WI (US); Brian ERIKSSON, San Jose, CA (US); Cong Han LIM, Madison, WI (US); Hasti SEIFI, Vancouver (CA); Subrahmanya Sandilya BHAMIDIPATI, Snnnyvale (CA); Shahab HAMIDI-RAD, Sunnyvale, CA (US); Annamalai NATARAJAN, Amherst, MA (US); Paris SYMINELAKIS, Palo Alto, CA (US)

(73) Assignee: THOMSON Licensing, Issy-Les-Moulineaux (FR)

(21) Appl. No.: 16/063,285

(22) PCT Filed: Dec. 15, 2016
(86) PCT No.: PCT/EP2016/081265

§ 371 Date: Jun. 17, 2018

Related U.S. Application Data
(60) Provisional application No. 62/268,644, filed on Dec. 17, 2015.
(60) Provisional application No. 62/268,640, filed on Dec. 17, 2015.

(51) Int. Cl. H04N 21/454; H04N 21/845; G06K 9/62; G02B 27/01; G06T 19/00

(52) U.S. Cl. CPC H04N 21/4542; H04N 21/8456; G02B 2027/0178; G02B 27/0172; G06T 19/006; G06K 9/6223

(57) ABSTRACT

The present principles generally relate to augmented reality (AR) apparatuses and methods, and in particular, to an exemplary augmented reality system (100) in which content characteristics are used to affect the individual viewing experience of the content. One exemplary embodiment involves a user specified modification of the content by using an augmented reality device (125-1) to provide a preview for a parent or a guardian of a viewer, or a third-party curator of contents a time period before a potentially objectionable scene is to be shown to other viewers. A modified content (705, 1005) may be created by replacing or obscuring the objectionable content or scenes of the one or more of the original contents. The apparatus and method is employed in a system having one or more augmented reality devices (125-1-125-n) such as e.g., one or more pairs of AR glasses. The system may also include a non-AR display screen (191, 192) to display the content to one or more viewers. Accordingly, different forms of the same content may be presented on the different AR glasses and also on the shared screen.

### BACKGROUND OF THE INVENTION

### Field of the Invention

The present principles generally relate to augmented reality (AR) apparatuses and methods, and in particular, to an exemplary augmented reality system in which content characteristics are used to affect the individual viewing experience of the content.

### Background Information

This section is intended to introduce a reader to various aspects of art, which may be related to various aspects of the present principles that are described and/or claimed below. This discussion is believed to be helpful in providing the reader with background information to facilitate a better understanding. Accordingly, it should be understood that these statements are to be read in this light, and not as admissions of prior art.

Augmented reality (AR) is a live direct or indirect view of a physical, real-world environment whose elements are augmented (or supplemented) by computer-generated sensory inputs such as, e.g., sound, video, graphics, GPS data, and/or other data. It is related to a more general concept called mediated reality, in which a view of reality is modified by a computer. As a result, the technology functions by enhancing one's current perception of reality. Augmented reality is the blending of virtual reality (VR) and real life, as developers can create images within applications that blend in with contents in the real world. With augmented reality devices, users are able to interact with virtual contents in the real world, and are able to distinguish between the two.

One well-known AR device is Google Glass developed by Google X. Google Glass is a wearable computer which has a video camera and a head mounted display in the form of a pair of glasses. In addition, various improvements and apps have also been developed for the Google Glass.

### SUMMARY OF THE INVENTION

Accordingly, an exemplary method is presented, comprising: acquiring metadata associated with video content to be displayed by an augmented reality (AR) video apparatus, the AR apparatus including a display screen and a pair of AR glasses, the metadata indicating respectively a characteristic of a corresponding scene of the video content; acquiring viewer profile data, the viewer profile data indicating viewing preference of at least one of viewers of the video content; determining a plurality of objectionable scenes included in the video content based on the viewer profile data and said metadata; clustering the plurality of objectionable scenes in groups of objectionable scenes according to the characteristic comprised in the respective metadata; selecting in each of said groups one representative objectionable scene; and providing objectionable scenes on the pair of AR glasses.

In another exemplary embodiment, an apparatus is presented, comprising: a pair of AR glasses; a display screen; and a processor configured to: acquire metadata associated with video content to be displayed by the augmented reality video apparatus, the metadata indicating respectively a characteristic of a corresponding scene of the video content; acquire viewer profile data, the viewer profile data indicating viewing preference of at least one of viewers of the video content; determine a plurality of objectionable scenes included in the video content based on the viewer profile data and said metadata; cluster said plurality of objectionable scenes in groups of objectionable scenes according to said characteristic comprised in said respective metadata; in each of said groups, select one representative objectionable scene; and provide objectionable scenes on the pair of AR glasses.

In another exemplary embodiment, a computer program product stored in a non-transitory computer-readable storage medium is presented, comprising acquiring metadata associated with video content to be displayed by an augmented reality (AR) video apparatus, the AR apparatus including a display screen and a pair of AR glasses, the metadata indicating respectively a characteristic of a corresponding scene of the video content; acquiring viewer profile data, the viewer profile data indicating viewing preference of at least one of viewers of the video content; determining a plurality of objectionable scenes included in the video content based on the viewer profile data and said metadata; clustering the plurality of objectionable scenes in groups of objectionable scenes according to the characteristic comprised in the respective metadata; selecting in each of said groups one representative objectionable scene; and providing objectionable scenes on the pair of AR glasses.

### DESCRIPTION OF THE DRAWINGS

The above-mentioned and other features and advantages of the present principles, and the manner of attaining them, will become more apparent and the invention will be better understood by reference to the following description of embodiments of the present principles taken in conjunction with the accompanying drawings, wherein:

FIG. 1 shows an exemplary system according to the present principles;

FIG. 2 shows an example apparatus according to the present principles;

FIG. 3 shows an exemplary process according to the present principles;

FIG. 4 shows another exemplary process according to the present principles;

FIG. 5 shows an exemplary grouping of scenes of content using K-means clustering technique;

FIG. 6 to FIG. 10 show exemplary user interface screens according to the present principles; and

FIG. 11 shows another exemplary process according to the present principles; and

FIG. 12 shows another exemplary process according to the present principles.

The examples set out herein illustrate exemplary embodiments of the present principles. Such examples are not to be construed as limiting the scope of the invention in any manner.

### DETAILED DESCRIPTION

The present principles determine one or more viewers who are viewing video content in an augmented reality environment. Once a viewer's identity is determined by the AR system, his or her viewer profile data may be determined from the determined identity of the viewer. In addition, respective content metadata for one or more video contents available for viewing on the AR system are also acquired and determined in order to provide respectively a content profile for each content. A comparison of the content profile and the viewer profile may then be performed. The result of the comparison is a list of possibly objectionable scenes and the corresponding possible user selectable actions. One exemplary user selectable actions may be a modification such as, e.g., a replacement or an obscuring of a potentially objectionable scene of the video content.

Therefore, a modified content may be created by replacing or obscuring the objectionable content or scenes of the one or more of the original contents. In one exemplary embodiment, the modification of the content may be performed a period of time before a potentially objectionable content is to be shown to the one or more viewers of the content. In another exemplary embodiment, the modification is performed by a parent or a guardian of at least one of the viewers. In another exemplary embodiment, the modification is performed by a curator of the video content (e.g., a keeper, a custodian and/or an acquirer of the content).

In another embodiment, an exemplary apparatus and method is employed in a system having one or more augmented reality devices such as e.g., one or more pairs of AR glasses. The system may also include a non-AR display screen to display and present the content to be viewed and shared by one or more viewers. Accordingly, different forms of the same content may be presented on the different AR glasses and also on the shared screen.

In another aspect, the present principles provide an advantageous AR system to efficiently distribute different forms of video content depending on the respective viewing profile data of the viewers. In one exemplary embodiment according to the present principles, an exemplary AR system determines whether an objectionable scene would be objectionable to a majority of the viewers. If it is determined that the objectionable scene would be objectionable to the majority of viewers, the system provides the video content in modified form to the display screen to be viewed and shared by the majority of viewers, and provides the video content in unmodified form to the plurality of AR glasses. If on the other hand, it is determined that the objectionable scene would not be objectionable to the majority of viewers, the system provides the video content in unmodified form to the display screen to be viewed and shared by the majority of viewers, and provides the video content in modified form to the plurality of AR glasses. In one embodiment, the exemplary AR system may be deployed in a people transporter such as an airplane, bus, train, or a car, or in a public space such as at a movie theater or stadium, or even in a home theater environment.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventors to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment”, “an embodiment”, “an exemplary embodiment” of the present principles, or as well as other variations thereof, means that a particular feature, structure, characteristic, and so forth described in connection with the embodiment is included in at least one embodiment of the present principles. Thus, the appearances of the phrase “in one embodiment”, “in an embodiment”, “in an exemplary embodiment”, or as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

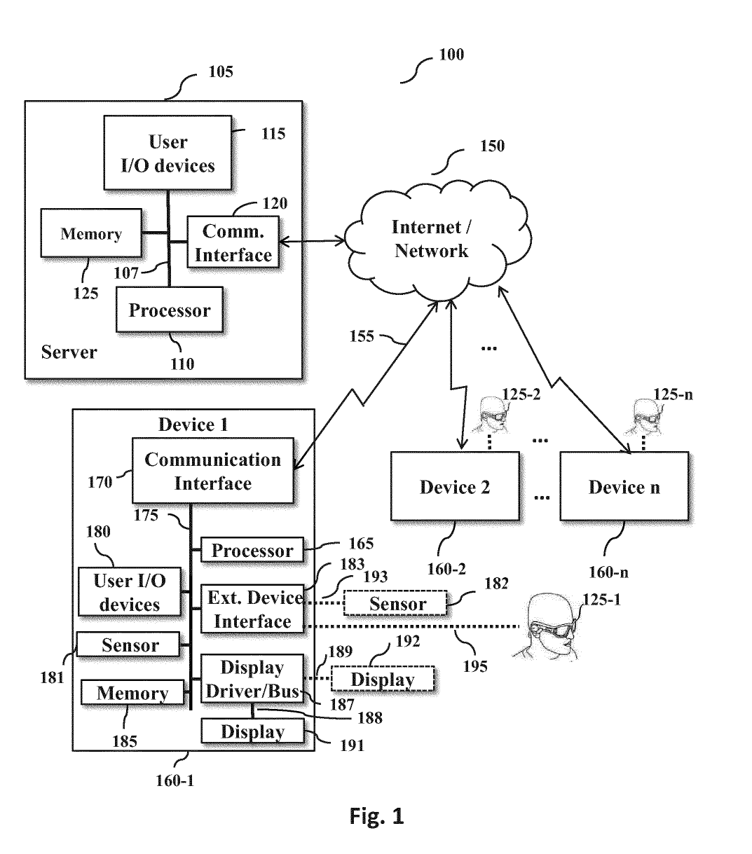

FIG. 1 illustrates an augmented reality (AR) system 100 according to the present principles. FIG. 1 at 100 provides a live direct or indirect view of a physical, real-world environment whose elements are augmented by computer processed or generated sensory inputs such as sound, video, graphics, GPS data, and/or other data. In one embodiment, the augmented reality system 100 may be enhanced, modified or even diminished accordingly by a processor or a computer. In this way and with the help of AR technology, the real world information available to a user may be further enhanced through digital manipulation. Consequently, additional information about a particular user's environment and its surrounding objects may be overlaid on the real world by digitally enhanced components. In another exemplary aspect, media content may be manipulated to be displayed differently for different devices and viewers of the AR system 100 as to be described further below.

An exemplary system 100 in FIG. 1 includes a content server 105 which is capable of receiving and processing user requests and/or other user inputs from one or more of user devices 160-1 to 160-n. The content server 105, in response to a user request for content, provides program content comprising various multimedia assets including video contents such as movies or TV shows for viewing, streaming or downloading by users using the devices 160-1 to 160-n. The content server 105 may also provide user recommendations based on the user rating data provided by the user and/or the user's watch history or behavior.

Various exemplary user devices 160-1 to 160-n in FIG. 1 may communicate with the exemplary server 105 over a communication network 150 such as, e.g., the Internet, a wide area network (WAN), and/or a local area network (LAN). Server 105 may communicate with user devices 160-1 to 160-n in order to provide and/or receive relevant information such as, e.g., viewer profile data, user editing selections, content metadata, recommendations, user ratings, web pages, media contents, and etc., to and/or from the user devices 160-1 to 160-n through the network connections. Server 105 may also provide additional processing of information and/or data when the processing is not available and/or is not capable of being conducted on the local user devices 160-1 to 160-n. As an example, server 105 may be a computer having a processor 110 such as, e.g., an Intel processor, running an appropriate operating system such as, e.g., Windows 2008 R2, Windows Server 2012 R2, Linux operating system, and etc.

User devices 160-1 to 160-n shown in FIG. 1 may be one or more of, e.g., a PC, a laptop, a tablet, a cellphone, or a video receiver. An example of such devices may be, e.g., a Microsoft Windows 10 computer/tablet, an Android phone/tablet, an Apple IOS phone/tablet, a television receiver, a set top box or the like. A detailed block diagram of an exemplary user device according to the present principles is illustrated in block 160-1 of FIG. 1 as Device 1 and is further described below.

An exemplary user device 160-1 in FIG. 1 comprises a processor 165 for processing various data and for controlling various functions and components of the device 160-1. The processor 165 communicates with and controls the various functions and components of the device 160-1 via a control bus 175 as shown in FIG. 1. For example, the processor 165 provides video encoding, decoding, transcoding and data formatting capabilities in order to play, display, and/or transport the video content.

Device 160-1 may also comprise a display 191 which is driven by a display driver/bus component 187 under the control of the processor 165 via a display bus 188 as shown in FIG. 1. The display 191 may be a touch display. In addition, the type of the display 191 may be, e.g., LCD (Liquid Crystal Display), LED (Light Emitting Diode), OLED (Organic Light Emitting Diode), and etc. In addition, an exemplary user device 160-1 according to the present principles may have its display outside of the user device, or that an additional or a different external display may be used to display the content provided by the display driver/bus component 187. This is illustrated, e.g., by an exemplary external display 192 which is connected to an external display connection 189 of device 160-1 of FIG. 1.

In additional, the exemplary device 160-1 in FIG. 1 may also comprise user input/output (I/O) devices 180 configured to provide user interactions with a user of the user device 160-1. The user interface devices 180 of the exemplary device 160-1 may represent e.g., a mouse, touch screen capabilities of a display (e.g., display 191 and/or 192), a touch keyboard, and/or a physical keyboard for inputting various user data. The user interface devices 180 of the exemplary device 160-1 may also comprise a speaker or speakers, and/or other user indicator devices, for outputting visual and/or audio sounds, user data and feedbacks.

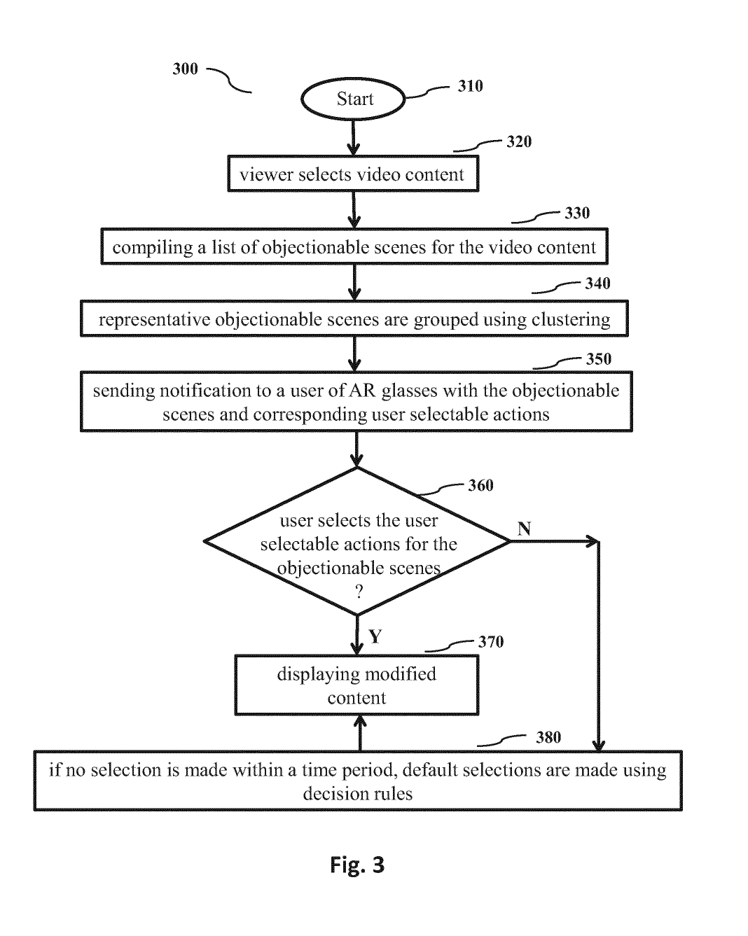

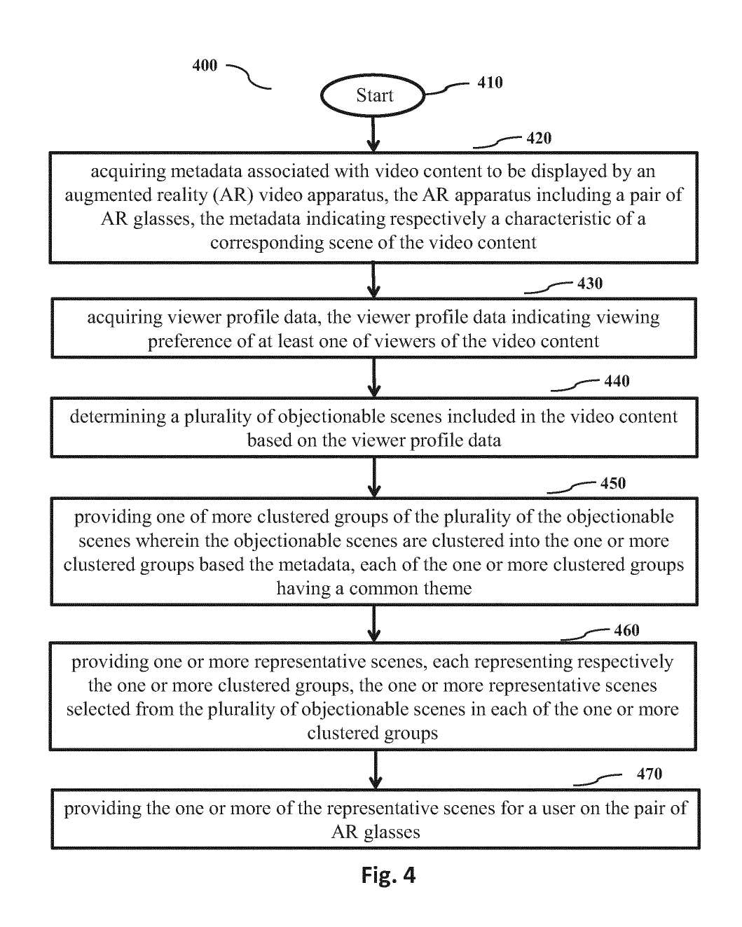

Exemplary device 160-1 also comprises a memory 185 which may represent both a transitory memory such as RAM, and a non-transitory memory such as a ROM, a hard drive, a CD drive, a Blu-ray drive, and/or a flash memory, for processing and storing different files and information as necessary, including computer program products and software (e.g., as represented by flow chart diagrams of FIG. 3 and FIG. 4, as to be discussed below), webpages, user interface information, various databases, and etc., as needed. In addition, device 160-1 also comprises a communication interface 170 for connecting and communicating to/from server 105 and/or other devices, via, e.g., the network 150 using the link 155 representing, e.g., a connection through a cable network, a FIOS network, a Wi-Fi network, and/or a cellphone network (e.g., 3G, 4G, LTE, 5G), and etc.

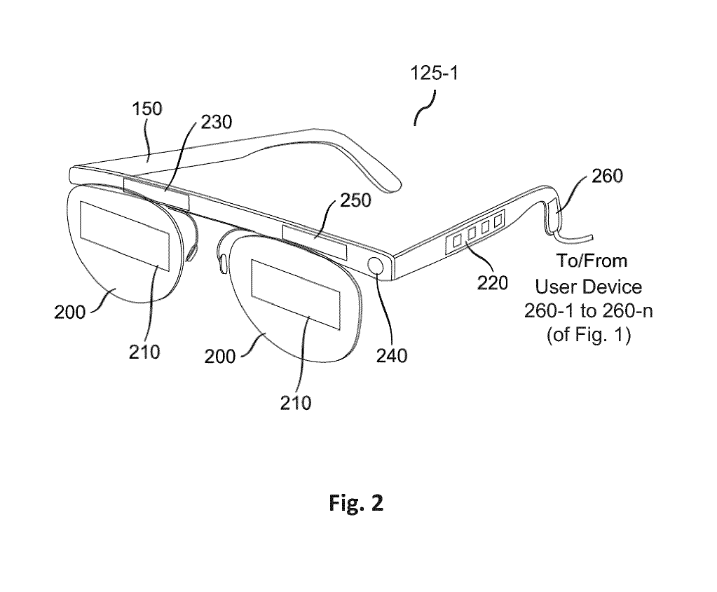

Also as shown in FIG. 1, each of the user devices 160-1 to 160-n may have an exemplary pair of augmented reality (AR) glasses 125-1 to 125-n attached thereto and being used by a respective user of the respective user device. As an example, a pair of augmented reality (AR) glasses 125-1 is attached to the exemplary user device 160-1 via an external device interface 183 through a connection 195 according to the present principles. Accordingly, the one or more user devices 160-1 to 160-n shown in FIG. 1 may acquire augmented reality (AR) functionalities through the respective AR glasses 125-1 to 125-n and may become AR capable apparatuses. The details of an exemplary pair of AR glasses 125-1 will be described further in connection with FIG. 2 below.

According to the present principles, AR system 100 may determine one or more viewers who are viewing video content in the augmented reality environment of 100. An exemplary device 160-1 in FIG. 1 may also comprise a sensor 181 configured to detect presence of a viewer within a vicinity of the user device 160-1 and to determine the identity of the viewer. An example of a sensor 181 may be a biometric sensor to obtain biometric data of the viewer. An exemplary biometric sensor 181 may be a physiological sensor used to gather biometric data such as, e.g., a viewer's finger print, retinal image and/or GSR (Galvanic Skin Response) in order to identify the viewer.

Another example of a sensor 181 may be an audio sensor such as a microphone, and/or a visual sensor such as a camera so that voice recognition and/or facial recognition may be used to identify a viewer, as is well known in the art. In another exemplary embodiment according to the present principles, sensor 181 may be a RFID reader for reading a respective RFID tag having the identity of the respective viewer already pre-provisioned. In another example, sensor 181 may represent a monitor for monitoring a respective electronic connection or activity of a person or a person's device in a room or on a network. Such an exemplary person identity sensor may be, e.g., a Wi-Fi router which keeps track of different devices or logins on the network served by the Wi-Fi router, or a server which keeps track of logins to emails or online accounts being serviced by the server. In addition, other exemplary sensors may be location-based sensors such as GPS and/or Wi-Fi location tracking sensors, which may be used in conjunction with e.g., applications commonly found on mobile devices such as the Google Maps app on an Android mobile device that can readily identify the respective locations of the users and the user devices.

Also as shown in FIG. 1, an example of a viewer identification sensor 181 may be located inside the user device 160-1. In another non-limiting embodiment according to the present principles, an exemplary external sensor 182 may be separate from and located external to the user device 160-1 (e.g., placed in the room walls, ceiling, doors, etc.). The exemplary external sensor 182 may have a wired or wireless connection 193 to the device 160-1 via the external device interface 183 of the device 160-1, as shown in FIG. 1. In addition, it is noted that the AR glasses 125-1 of device 160-1 shown in FIG. 1 also comprises one or more sensors which may also be used in a similar manner as described for sensors 180 and 182 herewith. The sensors for AR glasses 125-1 will be further described in connection with FIG. 2 below. In addition, the external device interface 183 of the device 160-1 may also represent a device interface such as a USB port or a FireWire interface port that would allow external storage memories such as external hard drives (not shown) or USB memories (not shown) to be used to storage media content to be imported and played by the device 160-1.

Continuing with FIG. 1, exemplary user devices 160-1 to 160-n may access different media assets, recommendations, web pages, services or various databases provided by server 105 using, e.g., HTTP protocol. A well-known web server software application which may be run by server 105 to service the HTTP protocol is Apache HTTP Server software available from http://www.apache.org. Likewise, examples of well-known media server software applications for providing multimedia programs may include, e.g., Adobe Media Server, and Apple HTTP Live Streaming (HLS) Server. Using media server software as mentioned above and/or other open or proprietary server software, server 105 may provide media content services similar to, e.g., Amazon, Netflix, or M-GO as noted before. Server 105 may also use a streaming protocol such as e.g., Apple HTTP Live Streaming (HLS) protocol, Adobe Real-Time Messaging Protocol (RTMP), Microsoft Silverlight Smooth Streaming Transport Protocol, and etc., to transmit various programs comprising various multimedia assets such as, e.g., movies, TV shows, software, games, electronic books, electronic magazines, and etc., to the end-user device 160-1 for purchase and/or viewing via streaming, downloading, receiving or the like.

FIG. 1 also illustrates further detail of an exemplary web and content server 105. Server 105 comprises a processor 110 which controls the various functions and components of the server 105 via a control bus 107 as shown in FIG. 1. In addition, a server administrator may interact with and configure server 105 to run different applications using different user input/output (I/O) devices 115 (e.g., a keyboard and/or a display) as well known in the art.

Server 105 also comprises a memory 125 which may represent both a transitory memory such as RAM, and a non-transitory memory such as a ROM, a hard drive, a CD Rom drive, a Blu-ray drive, and/or a flash memory, for processing and storing different files and information as necessary, including computer program products and software (e.g., as represented by flow chart diagrams of FIG. 3 and FIG. 4, as to be discussed below), webpages, user interface information, user profiles, user recommendations, user ratings, metadata, electronic program listing information, databases, search engine software, and etc. Search engine software may also be stored in the non-transitory memory 125 of sever 105 as necessary, so that media recommendations may be provided, e.g., in response to a user's profile and rating of disinterest and/or interest in certain media assets, and/or for searching using criteria that a user specifies using textual input (e.g., queries using “sports”, “adventure”, “Tom Cruise”, and etc.).

In addition, server 105 is connected to network 150 through a communication interface 120 for communicating with other servers or web sites (not shown) and one or more user devices 160-1 to 160-n, as shown in FIG. 1. The communication interface 120 may also represent television signal modulator and RF transmitter in the case when the content provider 105 represents a television station, cable or satellite television provider. In addition, one skilled in the art would readily appreciate that other well-known server components, such as, e.g., power supplies, cooling fans, etc., may also be needed, but are not shown in FIG. 1 to simplify the drawing.

According to the present principles, once a viewer's identity is determined by the AR system 100 as described above using sensors (e.g., 181 and/or 182), his or her viewer profile may be determined from the determined identity of the viewer. The viewer profile data of a viewer indicate viewing preferences (including viewing restrictions) of a viewer. The viewer profile may include data such as, e.g., age, political beliefs, religious preferences, sexual orientation, native language, violence tolerance, nudity tolerance, potential content triggers (e.g., PTSD, bullying), demographic information, offensive language, preferences (e.g., actors, directors, lighting), racial conflict, medical issues (e.g., seizures, nausea), and etc.

In one exemplary embodiment according to the present principles, the viewer profile data may be acquired from a pre-entered viewer profile data already provided by each corresponding viewer of the AR viewing system 100. In another embodiment, the viewer profile may be acquired automatically from different sources and websites such as social network profiles (e.g., profiles on LinkedIn, Facebook, Twitter), people information databases (e.g., anywho.com, peoplesearch.com), personal devices (e.g., contact information on mobile phones or wearables), machine learning inferences, browsing history, content consumption history, purchase history, and etc. These viewer profile data may be stored in e.g., memory 125 of server 105 and/or memory 185 of device 160-1 in FIG. 1.

In addition, respective content metadata for one or more video contents available for viewing on the AR system 100 are also acquired and determined in order to provide a content profile for each content. Content metadata that are acquired and determined may comprise, e.g., content ratings (e.g., MPAA ratings), cast and crew of content, plot information, genre, offensive scene specific details and/or ratings (e.g., adult content, violence content, other triggers), location information, annotation of where AR-changes are available, emotional profile, and etc. Likewise, these content metadata may be acquired from auxiliary information embedded in the content (as provided by the content and/or the content metadata creator), crowdsourcing (internal and/or external). Accordingly, the content metadata may be gathered automatically by machine learning inferences and Internet sources such as third-party content databases (e.g., Rotten Tomatoes, IMDB); and/or manually provisioned by a person associated with the content and/or metadata provider. These content metadata may also be stored in e.g., memory 125 of server 105 and/or memory 185 of device 160-1 of FIG. 1.

According to the present principles, a comparison of the content profile and the viewer profile may be performed by e.g., processor 110 and/or processor 165. The comparison of content profile and viewer profile may be performed via e.g., a hard threshold based on the viewer profile data. That is, for example, if the viewer's age is less than 10, and therefore, the content with adult or nudity scenes will be deemed objectionable to the viewer. The comparison may also be done using a soft threshold by machine learning inferences to determine viewing patterns.

Accordingly, this comparison determines whether the content is appropriate to a viewer and whether content modification should be first performed by e.g., a parent or a guardian of the viewer, as to be further described below. Therefore, this comparison may be performed by a content provider 105, the viewer, or a third-party (e.g., parent/guardian or an external organization). This comparison may be done in real-time or off-line. The result of the comparison is a list of possibly objectionable scenes and the corresponding possible user selectable actions for the video content.

In one embodiment, the content server 105 is aware of when the objectionable content will be presented to the viewers. It can then detect that a pre-screening by a parent/guardian/curator is required using the viewer's user profile information. The content provider will then present a preview of the questionable scenes. For example, when an age/gender/race inappropriate person is watching a particular content by himself or herself with no parent/guardian/curator present, the streaming service 105 would notify the parent/guardian/curator with a representative list of objectionable scenes and a corresponding list of actions that could be applied to these scenes. In another embodiment, one or more of the above functions may be performed by the user device 160-1 in conjunction with the AR glasses 125-1, as to be described further below.

The representative list of objectionable scenes is created from the whole list of objectionable scenes by clustering the inappropriate scenes into groups based on a similarity measure. One way to do this clustering is by using the well-known clustering algorithm such as the K-means algorithm. Of course, other well-known clustering algorithms may also be used to make the groupings as readily appreciated by one skilled in the art.

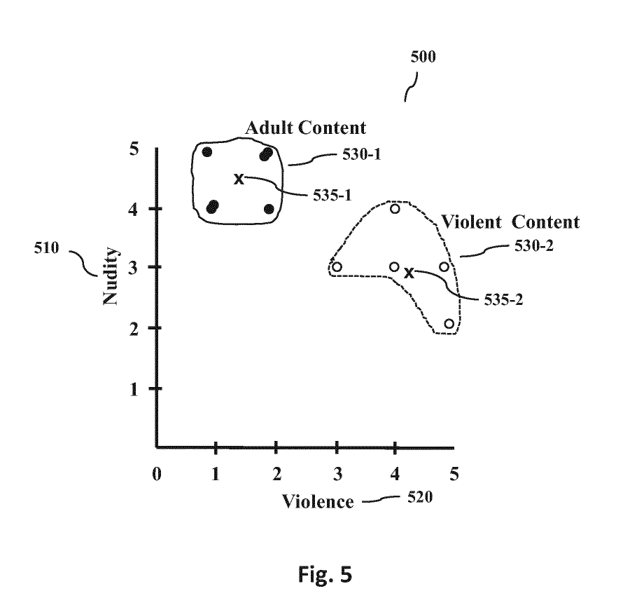

As shown in FIG. 5, in one exemplary embodiment according to the present principles, nudity content ratings 510 and violent content ratings 520 are provided for each one of the plurality of the selected scenes of the video content. When the K-means clustering algorithm is applied to these scenes as shown in FIG. 5, two clustered groups 530-1 and 530-2 are formed. Each group has a respective centroid as determined by the convergence of the K-means clustering algorithm. For example, the “Adult Content” scene group 530-1 has a corresponding centroid 535-1 and the “Violent Content” scene group 530-2 also has a corresponding centroid 535-2, as shown in FIG. 5. In one exemplary embodiment according to the present principles, a representative scene is selected from each clustered group and added to the list of objectionable groups of scenes.

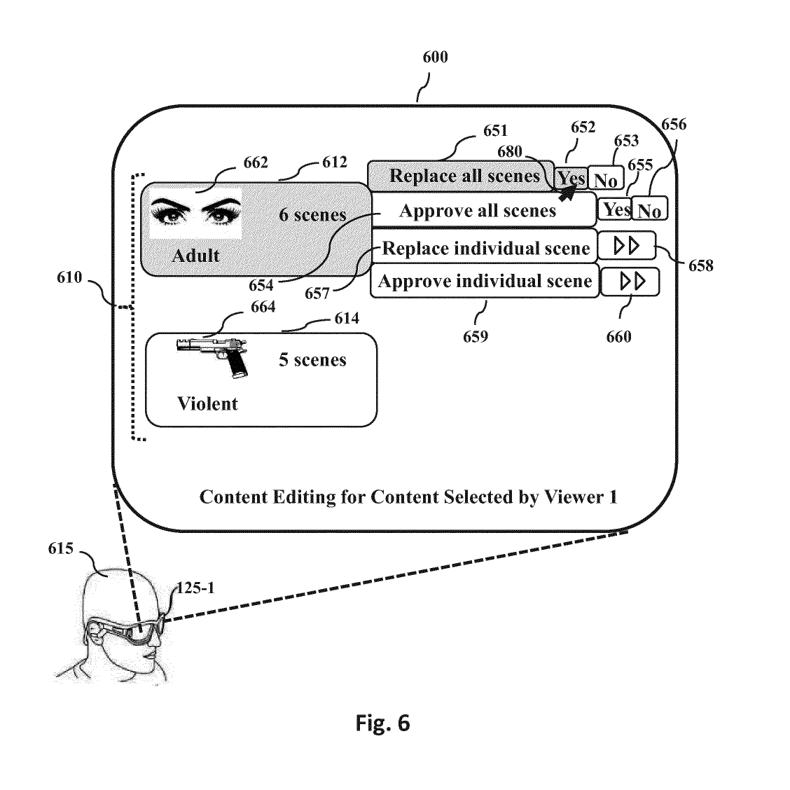

The representative scene for each group may be selected, e.g., based on the objectionable scene which is the closest to the centroid of the corresponding group. Thereafter, for example, the video clip of the representative scene will be displayed to represent the respective clustered group, as illustrated in elements 662 and 664 of FIG. 6, as to be described later. In an alternative embodiment, the image of the first video frame or another video frame of the selected representative scene may be used to convey the representative scene in the list of the objectionable scenes 610 in the user interface 600 of FIG. 6, also as to be further described below.

One example of a machine learning aspect of the present principles is by using computer algorithms to automatically determine e.g., the nudity and violent scenes of the video content and their respective nudity and violent ratings. Various well-known algorithms may be used to provide these functions and capabilities. For example, nudity scene detection and a corresponding rating for a video scene may be determined by using various skin detection techniques, such as those described in and referenced by, e.g., in H. Zheng, H. Liu, and M. Daoudi, “Blocking objectionable images: adult images and harmful symbols,” in Proceedings of the IEEE International Conference on Multimedia and Expo (ICME), June 2004, pp. 1223-1226. In addition, many other nudity detection algorithms are also described may be used such as, e.g., described in and referenced by Lopes, A., Avila, S., Peixoto, A., Oliveira, R., and de A. Ara´ujo, A. (2009), “A bag-of-features approach based on hue-sift descriptor for nude detection”, European Signal Processing Conference (EUSIPCO), pages 1552-1556.

Likewise, various violent scene detection techniques have also been proposed and may be used to automatically determine violent scenes in video content and provide associated ratings in accordance with the present principles, as described, e.g., in C. H. Demarty, B. Ionescu, Y. G. Jiang, and C. Penet, Benchmarking Violent Scenes Detection in movies, Proceedings of the 2014 12th International Workshop on Content-Based Multimedia Indexing (CBMI), 2014. For example, violent scene detection and ratings may be determined by the occurrence of bloody images, facial expressions, and motion information, as described in Liang-Hua Chen, et al., “Violence Detection in Movies”, Computer Graphics, Imaging and Visualization (CGIV), 2011 Eighth International Conference on Computer Graphics, Imaging & Visualization. As the authors of the above article noted, the experimental results show that the proposed approach works reasonably well in detecting most of the violent scenes in the content.

In one embodiment according to the present principles, content provider 105 may provide the content which already has the associated content metadata that define precisely which plurality of frames constitute one scene of the content. The provided metadata also include a corresponding description in the metadata to describe the characteristics of the scene. Such characteristics may include, for example, violence and nudity ratings from 1 to 5. In one exemplary embodiment, such characterization data may be provisioned by a content screener manually going through the content and delineating each scene of interest for the entire content.

In another exemplary embodiment, a collection of descriptive words may be collected for each scene from the content metadata and a similarity measure of the collection of words may be a distance measurement between the respective collections of the words for scenes. This information is then used to cluster the scenes together (for example, nudity, violence, horror groups) using the well-known K-means algorithm as described before.

Thereafter, the notification being provided may be a representative list of the clustered groups of objectionable scenes along with corresponding actions which may be performed by a user (e.g., editing actions such as, e.g., remove, replace, or approve). In another alternative embodiment, a default set of actions may be automatically provided. The default set of actions may be created based one or more filters (such as, e.g., children friendly, race friendly, religion friendly images or scenes replacements) created beforehand. Therefore, if no action is taken by the user within a certain time period, a default filter may be applied accordingly.

The modification of the video content may be an overlay of a replacement content over the original content to be shown on a display device. For this modification to be performed, each scene of the video content is defined and associated with an appropriate content profile, as described above. In addition, each element of a scene may be associated with such a profile. For example, each area of a nudity scene may be defined to detail the spatial characteristics of the area. This may be done via coordinates, shape map, polygon definition, etc., as well known in the art.

FIG. 2 illustrates the details of an exemplary pair of AR glasses 125-1 as shown in FIG. 1. The AR glasses 125-1 is in the shape of a pair of glasses 150 worn by a user. The AR glasses 125-1 comprises a pair of lenses 200, with each lens including a rendering screen 210 for display of additional information received from e.g., the processor 165 of the exemplary user device 160-1 of FIG. 1. The AR glasses 125-1 may also comprise different components that may receive and process user inputs in different forms such as touch, voice and body movement. In one embodiment, user inputs may be received from a simple touch interaction area 220 useful to allow a user to control some aspects of the augmented reality glasses 125-1.

In addition, the AR glasses 125-1 also includes a communication interface 260 which is connected to the external device interface 183 of the user device 160-1 of FIG. 1. The interface 260 includes a transmitter/receiver for communicating with the user device 160-1. This interface 260 may be either a wireless interface, such as Wi-Fi, or a wired interface, such as an optical or wired cable. Interface 260 enables communication between user device 160-1 and AR glasses 125-1. Such communication includes user inputs to user device 160-1, such as user selection information to the user device 160-1, and user device 160-1 to AR glasses 125-1 transmissions, such as information for display by the rendering screens 210 on the AR glasses 125-1. This connection to device 160-1 also allows the AR glasses 125-6 to be controlled using the user I/O devices 180 of the device 160-1 as described previously in connection with FIG. 1, and also allows the output of the AR glasses to be displayed on one or more of the displays 191 and 192 of the user device 160-1 of FIG. 1, and vice versa.

The user device 160-1 in the embodiment of FIG. 1 may be in communication with touch interaction area 220, sensor(s) 230 and microphone(s) 240 via a processor 250 of the AR glasses 125-1. Processor 250 may represent one or a plurality of processors. The sensor(s) 230, in one embodiment, may be one or more of the exemplary sensors as described above in connection with sensors 181 and 182 of FIG. 1 (e.g., a camera or a biometric sensor, etc.), a motion sensor, sensors which react to light, heat, moisture, and/or sensors which include gyros and compass components, and etc.

In the example depicted in FIG. 2, a plurality of processors 250 may be provided in communication with one another. By way of example, the processors represented by 250 may be embedded in different areas, one in the touch interaction area 220 and another one in head mounted components on AR glasses 125-1. However, this is only one embodiment. In alternate embodiments, only one processor may be used and the processor may be freestanding. In addition, the processor(s) may be in processing communication with other computers or computing environments and networks.

In the embodiment of FIG. 2, AR glasses 125-1 is head mounted and formed as a pair of glasses 150. In practice, the AR glasses 125-1 may be any device able to provide a transparent screen in a line of sight of a user for projection of the additional information thereon at a position that does not obstruct viewing of the content being displayed. The AR glasses 125-1 comprise the pair of see-through lenses 200 including the rendering screens 210. In one embodiment, AR glasses 125-1 may be a pair of ordinary glasses 150 that may be worn by a user and rendering screens 210 may be permanently and/or temporarily added to the ordinary glasses for use with the AR system 100 shown in FIG. 1.

In one embodiment as shown in FIG. 2, the various components of the head mounted AR glasses 125-1 as discussed above (such as, e.g., the microphone, touch interaction area, rendering screens and others) may be provided together and physically co-located as a unit. However, in another embodiment, some of these components may also be provided separately but still situated in one housing unit. Alternatively, some or none of the components may be connected or collocated or housed in the same unit as may be appreciated by those skilled in the art. Other embodiments may use additional components and multiple processors, computers, displays, sensors, optical devices, projection systems, and input devices that are in processing communication with one another as may be appreciated by those skilled in the art. Mobile devices such as smartphones and tablets which may include one or more cameras, micromechanical devices (MEMS) and GPS or solid state compass may also be used as part of the AR glasses 125-1.

As indicated, FIG. 2 is provided as an example but in alternative embodiments, components may be substituted and added or deleted to address particular selections preferences and/or needs. For example, in one embodiment, there is no need for the touch interaction area. The user may simply provide input by gestures alone due to the use of the sensors. In another embodiment, voice and gestures may be incorporated together. In other embodiments, one component may be substituted for another if it creates similar functionality. For example, the touch interaction area 220 may be substituted with a mobile device, such as a cell phone or a tablet.

Furthermore, the head mounted AR glasses 125-1 may be one of many alternatives that embed or allow the user to see a private screen through specialty lenses and may be a part of a head-mounted display (HMD), a headset, a harness, a helmet for augmented reality displays, or other wearable and non-wearable arrangements as may be appreciated by those skilled in the art. In the alternative, none of the components may be connected physically or a subset of them may be physically connected selectively as may be appreciated by those skilled in the art.

Referring back to the embodiment of FIG. 2, the sensor(s) 230, rendering screens or display 210 and microphone(s) 240, are aligned to provide virtual information to the user in a physical world capacity and will be responsive to adjustment accordingly with a user's inputs such as e.g., user selections of video editing choices, and the user's head and/or body movements to allow for an augmented reality experience.

FIG. 3 illustrates an exemplary process 300 according to the present principles. The exemplary process 300 starts at step 310. At step 320, a viewer of the exemplary system 100 selects an available video content for viewing. At step 330, a list of objectionable scenes is compiled for the video content as described previously in connection with FIG. 1. At step 340, the representative objectionable scenes are grouped using a selected one of different clustering techniques. Again, an exemplary, well-known K-means clustering algorithm may be used to provide the clustering, as described before and illustrated in FIG. 5. At step 350, a notification is sent to a user of an exemplary AR glasses (such as, e.g., the AR glasses 125-1 of the user device 160-1 shown in FIG. 1 and as described in detailed previously in connection with FIG. 2) with the objectionable scenes of the video content and the corresponding user selectable actions. An example of a list of the objectionable scenes is shown as element 610 in FIG. 6 and is to be described further below.

As determined at step 360 of FIG. 3, if the user selects one of the user selectable actions for the objectionable scenes within a time period, then the modified content will be displayed in, e.g., one or more of the display devices 191, 192, 125-1-125-n shown in FIG. 1, at step 370. If, however, the user does not select one of the user selectable actions for the objectionable scenes within a time period as determined at step 360, then default selections are made using decision rules at step 380. The default selections may be, e.g., by using one of a pre-selected replacement scene determined by the AR system 100, by using an automatic obscuring of a potentially objectionable scene, or by replacing or obscuring one or more objectionable elements on a video frame of a scene.

FIG. 4 illustrates another exemplary process 400 according to the present principles. The exemplary process 400 starts at step 410. At step 420, metadata associated with video content to be displayed by an augmented reality (AR) video apparatus (e.g., AR glasses 125-1 in FIGS. 1 and 2, and device 160-1 in FIG. 1) are acquired, the metadata indicating respectively a characteristic of a corresponding scene of the video content. At step 430, viewer profile data are acquired, the viewer profile data indicating viewing preference of at least one of viewers of the video content. At step 440, a plurality of objectionable scenes included in the video content are determined based on the viewer profile data.

At step 450 of FIG. 4, one of more clustered groups of the plurality of the objectionable scenes are provided wherein the objectionable scenes are clustered into the one or more clustered groups based the metadata, each of the one or more clustered groups having a common theme. At step 460, one or more representative scenes are provided, each representing respectively the one or more clustered groups, the one or more representative scenes are selected from the plurality of objectionable scenes in each of the one or more clustered groups. At step 470, the one or more of the representative scenes are provided for a user on the pair of AR glasses, such as e.g., AR glasses 125-1 in FIGS. 1 and 2, for a user on the pair of AR glasses. Again, the user of the pair of the AR glasses 125-1 may be e.g., a guardian or a parent of, or a curator of content for another viewer of the AR system 100 shown in FIG. 1.

FIG. 5 illustrates an exemplary well-known K-means clustering algorithm as already described in detail before. As noted before, the K-means clustering algorithm may be applied to provide clustered groups and their respective centroids for the one or more of the selected video scenes of the video content. In addition, information determined by the K-means algorithm shown in FIG. 5, such as information about the clustered groups of “Adult Content” 530-1 and “Violent Content” 530-2 shown in FIG. 5, may be used by and shown on an exemplary user interface screen 600 of the FIG. 6 as described below.

FIG. 6 to FIG. 10 illustrate various exemplary user interface screens according to the present principles. FIG. 6 shows an exemplary user interface screen 600 according to the present principles. This exemplary user interface screen 600 may be presented on the exemplary pair of AR glasses 125-1 of FIG. 1 and FIG. 2, to be worn by a guardian or parent of, or a curator/pre-screener 615 for another viewer of AR system 100 of FIG. 1, as described before. Furthermore, FIG. 6 shows an objectionable list of scenes 610 comprising two exemplary groups of the objectionable scenes 612 and 614. The two groups of the objectionable scenes 612 and 614 correspond respectively to the clustered groups of “Adult Content” 530-1 and “Violent Content” 530-2, as determined by the K-means algorithm shown in FIG. 5.

Each of the groups of the objectionable scenes 612 and 614 also has a corresponding video clip or a graphical image (as represented by elements 662 and 664) to provide efficient review for the objectionable content by the user 615. As described previously, a representative scene may be selected, e.g., based on the objectionable scene which is the closest to the centroid of the corresponding group as discussed previously in connection with FIG. 5. Thereafter, the video clip of the representative scene may be displayed automatically to represent the respective clustered group, as illustrated in elements 662 and 664 of FIG. 6. In an alternative embodiment, the image of the first video frame or another video frame of the selected representative scene may be used to convey the representative scene in the list of the objectionable scenes 610 in the user interface 600 of FIG. 6.

In addition, the user interface screen 600 also provides one or more of exemplary user selectable menu choices 651-660 for the list of the objectionable scenes 610. Therefore, the user 615 of the AR glasses 125-1 may accept or reject each of the one or more representative scenes being displayed on the AR glasses 125-1 by moving a selection icon 680 on the user interface screen 600 as shown in FIG. 6.

For example, a user may select “Yes” 652 for the “Replace all scenes” user selection icon 651 (illustrated in shaded background), and in response, all of the 6 scenes in the group of the adult content 612 will be replaced with a preselected non-objectionable scene. Of course, other user selectable edits are available by selecting the other user selection choices shown in FIG. 6. The other examples shown in FIG. 6 include e.g., “Approve all scenes” 654 which would allow a user 615 to accept all of scenes in the group 612 in their original form (i.e., no change is made to the original content). In another example, a user 165 may select to make individual replacement to each individual scene in the group of scenes 612. The user 615 may perform this edit by the selection of “Replace individual scene” selection icon 614 and then advance through each scene of the group 612 by selecting the advance icon 658 shown in FIG. 6. Likewise, the user 615 may also delete each individual scene of the group 612 by using icons 659 and 660 as shown in FIG. 6.

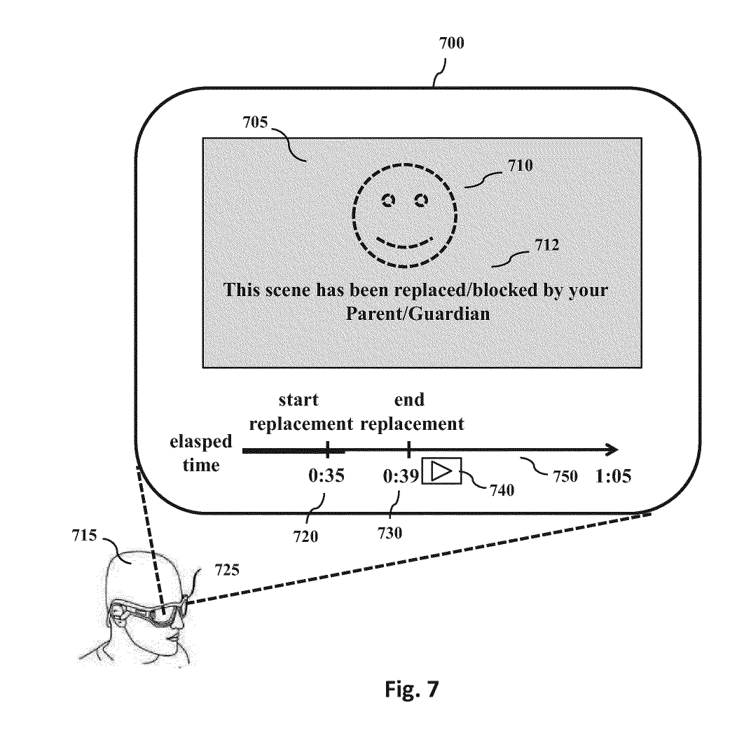

FIG. 7 is another exemplary user interface screen 700 according to the present principles. Screen 700 illustrates that, e.g., one of the objectionable scenes in the adult content group 612 shown previously in FIG. 6, has been replaced or blocked by, e.g., a parent or guardian or, or a curator for a viewer 715 viewing the video content 705 using a corresponding pair of AR glasses 725. The viewer 715 may represent one of more of the viewers of the AR system 100 shown in FIG. 1, and similarly, AR glasses 725 may represent one or more the exemplary AR glasses 125-1 to 125-n connected to the user devices 160-1 to 160-n in FIG. 1. In addition, as shown in FIG. 7, a replacement scene 710 is shown in FIG. 1. As an example, the replacement scene 710 is being used to replace an objectionable scene. In an alternative embodiment, instead of using a replacement scene 710, the original scene may simply be blanked or grayed out. In addition, a notification 712 of the modification of the content is provided to viewer 715 indicating that the content has been modified, as shown in FIG. 7

In addition, FIG. 7 also illustrates that an exemplary elapsed timeline 750 for the video 705 being played may be presented to the viewer 715. Furthermore, the start time 720 and the end time 730 for the modification of the video scene in the video content may also be presented to the viewer as shown in FIG. 7, so that the viewer is aware of when and/or for how long the modification has or will take place.

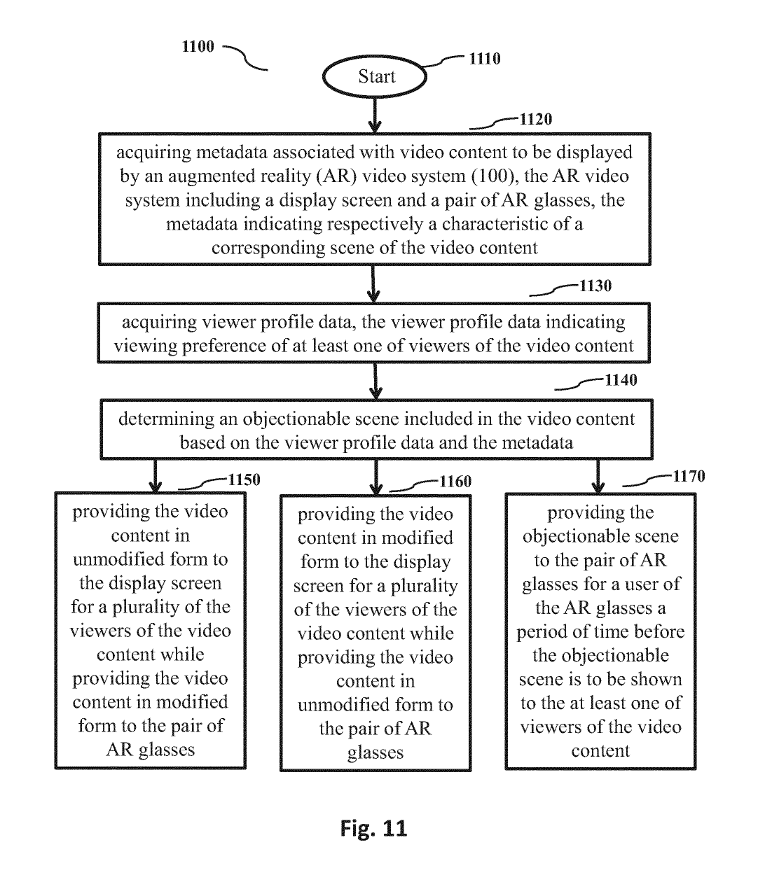

FIG. 11 illustrates another exemplary process 1100 according to the present principles. The exemplary process 1100 starts at step 1110. At step 1120, metadata associated with video content to be displayed by an augmented reality (AR) video system (such as, e.g., the system 100 shown in FIG. 1) are acquired. The metadata indicate respectively a characteristic of a corresponding scene of the video content. As shown in FIG. 1 and as described previously, the exemplary AR video system 100 includes a screen (e.g., 191 or 192) and a pair of AR glasses (e.g., one of 125-1 to 125-n).

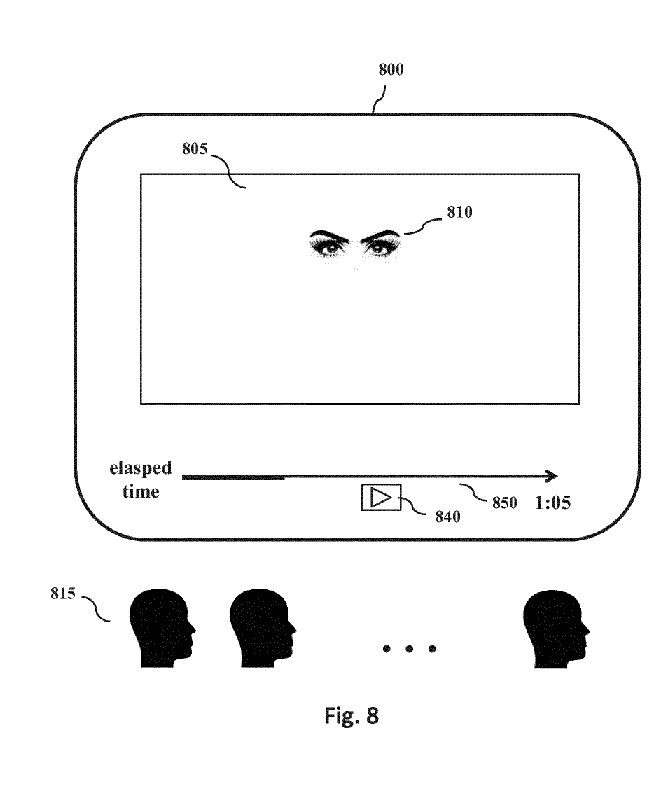

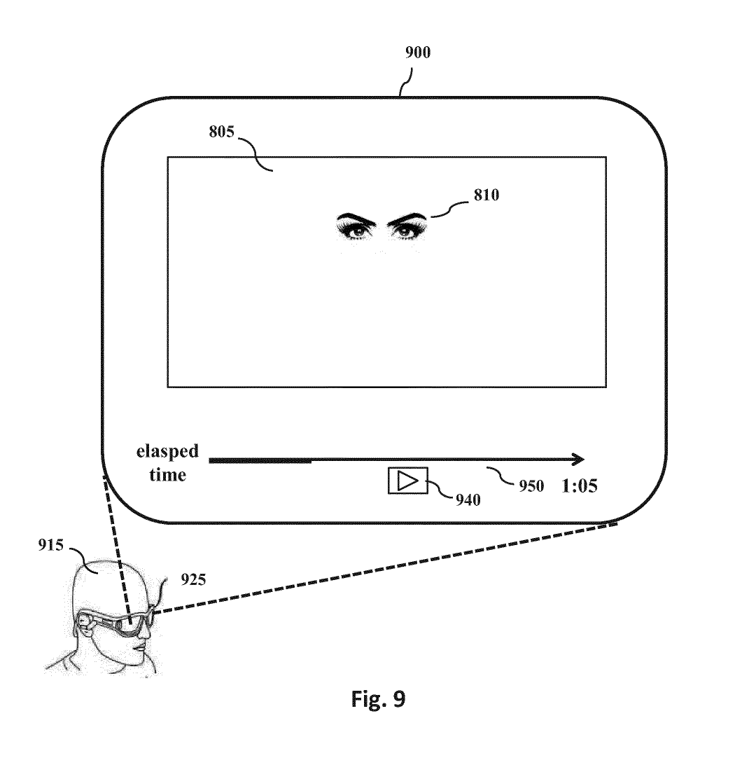

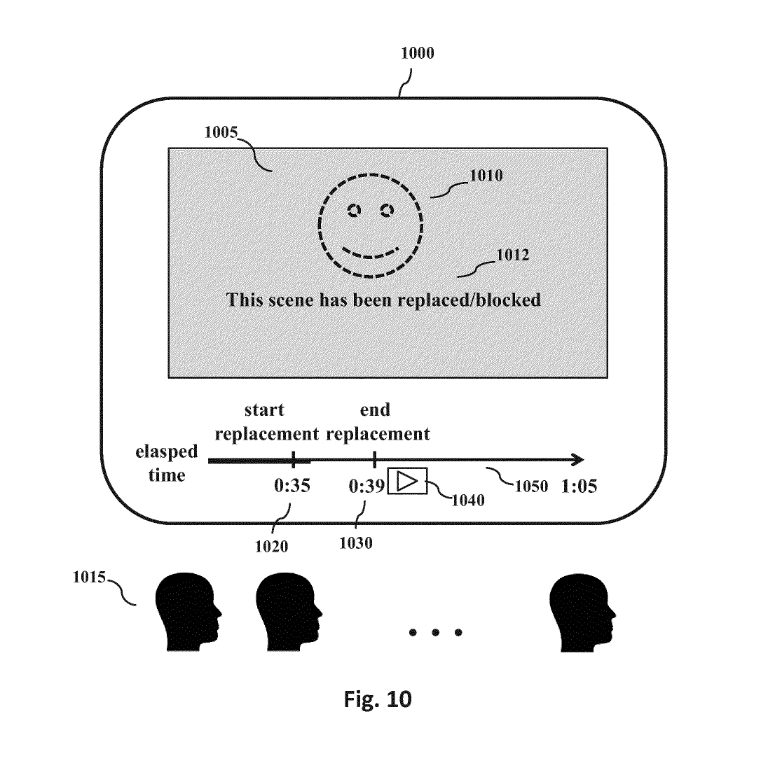

At step 1130 of FIG. 11, viewer profile data are acquired and the viewer profile data indicate viewing preference of at least one of viewers of the video content. At step 1140, an objectionable scene included in the video content is determined based on the viewer profile data and the metadata as described previously. At step 1150, the video content in unmodified form is provided to the display screen for a plurality of the viewers of the video content (as illustrated in an example user interface screen 800 of FIG. 8) while the video content in modified form is provided to the pair of AR glasses (as illustrated in an example user interface screen 700 of FIG. 7). Alternatively, at step 1150, the video content in modified form is provided to the display screen for a plurality of the viewers of the video content (as illustrated in an example user interface screen 1000 of FIG. 10) while the video content in unmodified form is provided to the pair of AR glasses (as illustrated in an example user interface screen 900 of FIG. 9).

In another exemplary embodiment as shown at step 1170, the objectionable scene of the video content is provided to the pair of AR glasses for a user of the AR glasses a period of time before the objectionable scene is to be shown to the at least one of viewers of the video content. Therefore the objectionable scene may be modified by the user before the modified content is shown to the other viewers. As described previously, the user modifying the content may be one of a parent or guardian of at least one of the viewers or a curator of the video content. Also as described before, the modification may be by replacing the objectionable scene with an un-objectionable scene, or by obscuring the objectionable scene.

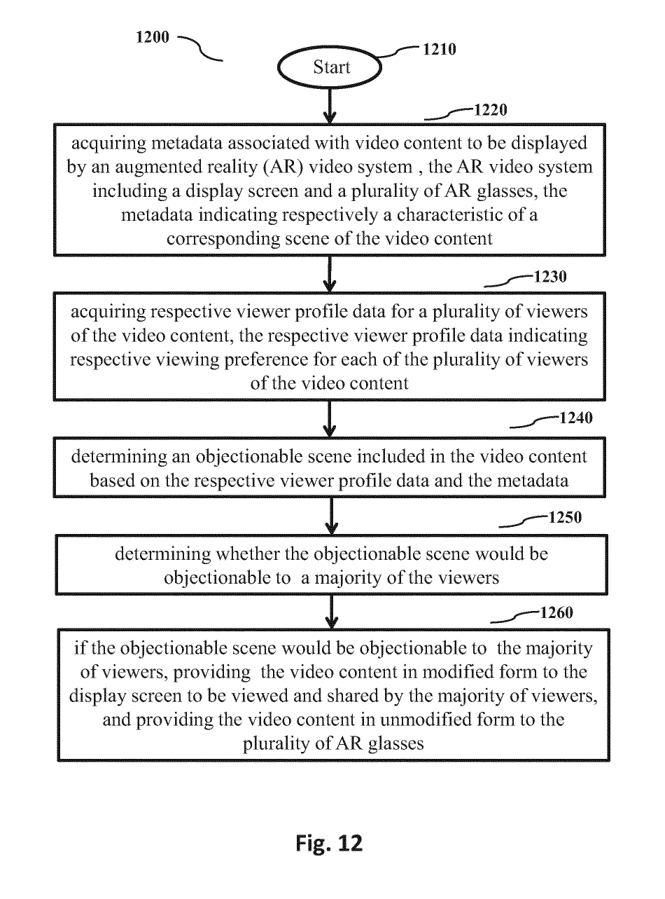

FIG. 12 illustrates another exemplary process 1200 according to the present principles. The exemplary process 1200 starts at step 1210. At step 1220, metadata are acquired. As already described before, the metadata are associated with video content to be displayed by an augmented reality (AR) video system (such as, e.g., the system 100 shown in FIG. 1), and indicate respectively a characteristic of a corresponding scene of the video content. Also as shown in FIG. 1 and as describe above, the exemplary AR video system 100 include a display screen 191 or 192 of FIG. 1, and a plurality of AR glasses, 125-1 to 125-n of FIG. 1.

At step 1230 of FIG. 12, respective viewer profile data for a plurality of viewers of the video content are acquired, the respective viewer profile data indicating respective viewing preference for each of the plurality of viewers of the video content. At step 1240, an objectionable scene included in the video content is determined based on the respective viewer profile data and the metadata. At step 1250, it is determined whether the objectionable scene would be objectionable to a majority of the viewers. This determination is based on the above determining step at 1240 of e.g., looking up each of the respective viewer profile data for each viewer, comparing the viewer profile data with the content metadata, and then counting whether or not more than 50% of the viewers would find the scene objectionable. At step 1260, if the objectionable scene would be objectionable to the majority of viewers, then the video content in modified form is provided to the display screen to be viewed and shared by the majority of viewers (as illustrated in an example user interface screen 1000 of FIG. 10), and the video content in unmodified form is also provided to the plurality of AR glasses (as illustrated in an example user interface screen 900 of FIG. 9). On the other hand, if the objectionable scene would not be objectionable to the majority of viewers, the video content in unmodified form is provided to the display screen to be viewed and shared by the majority of viewers (as illustrated in an example user interface screen 800 of FIG. 8), and the video content in modified form is also provided to the plurality of AR glasses (as illustrated in an example user interface screen 700 of FIG. 7).

Accordingly, the present AR video system is able to efficiently provide the appropriate form of the video content to a shared display screen to be viewed and shared by the majority of the viewers of the AR video system. Therefore, the present principles provide an AR video system which is well-suited to be deployed in a people transporter such as an airplane, bus, train, or a car, or in a public space such as at a movie theater or stadium, or even in a home theater environment where multiple viewers may enjoy a shared viewing experience even though some scenes of the shared content may not be preferred or appropriate for all of the viewers.

Also, in certain video editing applications in accordance with the present principles, virtual reality (VR) glasses may also be used to provide a private content editing experience for a user. Examples of some well-known VR glasses include e.g., Oculus Rift (see www.oculus.com), PlayStation VR (from Sony), Gear VR (from Samsung), and etc.

The foregoing has provided by way of exemplary embodiments and non-limiting examples a description of the method and systems contemplated by the inventors. It is clear that various modifications and adaptations may become apparent to those skilled in the art in view of the description. However, such various modifications and adaptations fall within the scope of the teachings of the various embodiments described above.

While several embodiments have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present embodiments. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings herein is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereof, the embodiments disclosed may be practiced otherwise than as specifically described and claimed. The present embodiments are directed to each individual feature, system, article, material and/or method described herein. In addition, any combination of two or more such features, systems, articles, materials and/or methods, if such features, systems, articles, materials and/or methods are not mutually inconsistent, is included within the scope of the present embodiment.

1. A method comprising:
acquiring metadata associated with video content to be displayed by an augmented reality (AR) video apparatus, the AR apparatus including a display screen and a pair of AR glasses, the metadata indicating respectively a characteristic of a corresponding scene of the video content;
acquiring viewer profile data, the viewer profile data indicating viewing preference of at least one of viewers of the video content;
determining a plurality of objectionable scenes included in the video content based on the viewer profile data and said metadata;
providing objectionable scenes on the pair of AR glasses, an objectionable scene being provided to the pair of AR glasses a period of time before having to be provided to the display screen; and
providing a user selection interface for a user wearing the AR glasses to accept or reject the one or more of the objectionable scenes provided to the pair of AR glasses and, if the user rejects an objectionable scene, modifying said objectionable scene.

2. (canceled)

3. The method of claim 1 further comprising:
clustering said plurality of objectionable scenes in groups of objectionable scenes according to said characteristic comprised in said respective metadata;
in each of said groups, selecting one representative objectionable scene;
providing only representative objectionable scenes are provided to the pair of AR glasses.

4. (canceled)

5. The method of claim 4 wherein if the user rejects an objectionable scene, replacing the rejected objectionable scene with a non-objectionable scene of the video content.

6. The method of claim 4 wherein if the user rejects an objectionable scene, obscuring the rejected objectionable.

7. The method of claim 1 wherein clustering said plurality of objectionable scenes in groups of objectionable scenes is based on a K-means algorithm.

8. The method of claim 7 wherein the selected representative objectionable scene in a group of objectionable scenes is an objectionable scene closest to a centroid of the K-means algorithm.

9. The method according to claim 4 further comprising displaying the video content with modified objectionable scenes on the display screen.

10. An augmented reality (AR) video apparatus comprising:
a pair of AR glasses;
a display screen; and
a processor configured to: acquire metadata associated with video content to be displayed by the augmented reality video apparatus, the metadata indicating respectively a characteristic of a corresponding scene of the video content; acquire viewer profile data, the viewer profile data indicating viewing preference of at least one of viewers of the video content; determine a plurality of objectionable scenes included in the video content based on the viewer profile data and said metadata; provide objectionable scenes on the pair of AR glasses, an objectionable scene being provided to the pair of AR glasses a period of time before having to be provided to the display screen; and provide a user selection interface (651-660) for a user wearing the AR glasses to accept or reject the one or more of the objectionable scenes provided to the pair of AR glasses and, if the user rejects an objectionable scene, modifying said objectionable scene.

11. (canceled)

12. The AR video apparatus of claim 10 wherein the processor is further configured to cluster said plurality of objectionable scenes in groups of objectionable scenes according to said characteristic comprised in said respective metadata and to select one representative objectionable scene in each of said groups; and wherein only representative objectionable scenes are provided to the pair of AR glasses.

13. (canceled)

14. The AR video apparatus of claim 13 wherein if the user rejects an objectionable scene, the processor is configured to replace the rejected objectionable scene with a non-objectionable scene of the video content.

15. The AR video apparatus of claim 13 wherein if the user rejects an objectionable scene, the processor is configured to obscure the rejected objectionable.

16. The AR video apparatus of claim 10 wherein the processor is configured to cluster said plurality of objectionable scenes in groups of objectionable scenes according to a K-means algorithm.

17. The AR video apparatus of claim 16 wherein the selected representative objectionable scene in a group of objectionable scenes is an objectionable scene closest to a centroid of the K-means algorithm.

18. The AR video apparatus according to claim 13 wherein the processor is further configured to display the video content with modified objectionable scenes on the display screen.
